(19) United States
(12) Patent Application Publication
(10) Pub. No.: US 2020/0181952 A1
(43) Pub. Date: Jun. 11, 2020

(54) MOTOR VEHICLE HANDLE ASSEMBLY

(71) Applicant: HUF HULSBECK & FURST GMBH & CO, Velbert (DE)

(72) Inventors: Mensur Velicanin, Velbert (DE); Martin Porada, Wuppertal (DE)

(73) Assignee: Huf Huelsbeck & Fuerst GmbH & Co. KG, Velbert (DE)

(21) Appl. No.: 16/322,025

(22) PCT Filed: Jun. 20, 2017
(86) PCT No.: PCT/EP2017/065036

§ 371 Date: Jan. 30, 2019

(30) Foreign Application Priority Data
Aug. 24, 2016 (DE) 10 2016 115 733.3

(51) Int. Cl. E05B 79/06; E05B 85/18; E05B 15/16; E05B 63/00

(52) U.S. Cl. CPC E05B 79/06; E05B 63/0056; E05B 15/16; E05B 85/18

(57) ABSTRACT

A motor vehicle handle assembly includes a rotatably mounted handle holder which has a first longitudinal end that can be mounted at a door or a hatch of a motor vehicle, and a handle element operable by a user. A second longitudinal end of the handle holder is configured to have at least one plug-in receptacle. The handle element has at least one fastening stud projecting from it. The at least one fastening stud of the handle element is disposed in the at least one plug-in receptacle in a plugged-in manner. A connecting element extends transversely to the insertion direction of the at least one fastening stud disposed in the handle holder in a plugged-in manner and through a passage opening of the at least one fastening stud. The at least one connecting element releasably and positively connects the handle holder and the handle element with each other.

The present invention relates to a motor vehicle handle assembly having a rotatably mounted handle holder, of which a first longitudinal end can be mounted on a door or hatch of a motor vehicle, and having a handle element operable by a user, a second longitudinal end of the handle holder being configured with at least one plug-in receptacle and the handle element having at least one fastening stud projecting from the handle element, and the at least one fastening stud of the handle element being disposed in a plugged-in manner in the at least one plug-in receptacle.

A motor vehicle handle assembly of the art described at the outset is, for example, known from the publication EP 3 002 397 A1. In this known construction for a motor vehicle handle assembly, fastening studs configured at a handle element have to be introduced at a predetermined angle into the plug-in receptacles molded into a handle holder. Subsequently thereto, the handle element has to be pivoted relative to the handle holder, as a result of which latching arms, which are configured in the plug-in receptacle and are elastically deformable, grip behind corresponding latching lugs formed at the fastening studs in such a manner that the handle element is attached to the handle holder. In this known prior art, the latching connection is configured in a complex manner and, due to its complexity, prone to damage because there is always the danger during assembly and disassembly that a hook-shaped latching arm or latching lug can break off, for example. Due to the complex geometry of latching arm and latching lug, the manufacture of the known construction furthermore is also costly.

The object of the present invention is therefore to achieve that an improved motor vehicle handle assembly is provided in a structurally simple way, which is quickly installed and which at the same time has a secure connection between handle holder and handle element and has a robust construction.

In a motor vehicle handle assembly of the type described at the outset, the object is achieved according to the present invention in that at least one connecting element is provided, which extends transversely to the insertion direction of the fastening stud disposed in the handle holder in a plugged-in manner and through a passage opening of the fastening stud, the at least one connecting element releasably and positively connecting the handle holder and the handle element with each other.

Advantageous and appropriate embodiments and further refinements of the present invention result from the dependent claims.

The present invention provides a motor vehicle handle assembly for a door or a hatch of a motor vehicle, which is distinguished by a functionally appropriate construction and which has a compact and cost-effective design. According to the present invention, the handle holder and the handle element are connected with each other via a positive connection, as a result of which a secure attachment of the handle element to the handle holder is ensured while the installation is simultaneously simplified. Furthermore, the releasable connection between the handle holder and the handle element provides the opportunity to retroactively replace the handle element.

For a compact handle assembly requiring little space, the present invention provides in its embodiment that the handle holder is formed having at least one lever-shaped swing arm, the plug-in receptacle being formed at the free longitudinal end of the at least one swing arm. To increase the stability of the handle assembly, the handle holder, for example, can be equipped with two swing arms, which are releasably connected with the handle element.

In a further embodiment, the present invention provides that at least one fastening stud is configured having at least one latching lug, which, in the fastening studs disposed in a plugged-in manner in the at least one plug-in receptacle, engages behind a holding section configured within the at least one plug-in receptacle in such a manner that a movement of the fastening stud in a movement directed out of the plug-in receptacle is blocked. This way, an unwanted cancellation of the connection of handle element and handle holder is prevented.

In a further embodiment of the present invention, it is provided that the handle element is formed by a handle and a lid-like cover plate, the handle for accommodating electrical components having a receiving space closed off by the cover plate. Consequently, the receiving space can also be used to accommodate electronic components which can affect an electric opening process. Furthermore, on the basis of the multi-part design of the handle element, the cover plate can be replaced easily and quickly with reasonable complexity.

To increase the flexibility and possible applications of the motor vehicle handle assembly, the present invention in a further embodiment provides that the at least one fastening stud is configured as an inserter component, which is fixed in sections in the receiving space of the handle and extends through an opening formed in the handle. The inserter component can consequently also be matched with different handle holders, the handle element being unaltered. Likewise, an inserter component can be replaced if a respective wear or damage is present. Accordingly, the handle element is modularly constructed and is adaptable to different vehicle types and different handle holders.

According to a further embodiment of the motor vehicle handle assembly according to the present invention, it is advantageous if the inserter component has a base body and a fixation surface configured at the body, and a latching hook configured in the receiving space of the handle engages at the fixation surface and a support surface formed onto the base body pushes on the edge of the opening in such a manner that the inserter component is releasably fixed to the handle.

The present invention provides in a further embodiment that the insertion component is made of Zamak. Zamak are zinc die-casting alloys that enable the production of very complex die-cast parts having a plurality of surface design options.

Finally, in a further embodiment of the present invention it is provided that at least one connecting element is a screw, which is screwed in at least into the handle holder transversely to the insertion direction of the fastening stud and which extends through the passage opening configured in the fastening stud. The connecting element configured as a screw enables a releasable and restorable connection of handle element and handle holder.

It is understood that the previously mentioned and subsequently still to be described features not only may be used in the respectively specified combination but also in other combinations or they may be used standing on their own without leaving the scope of the present invention. The scope of the present invention is only defined by the claims.

Further details, features and advantages of the subject of the present invention result from the subsequent description in conjunction with the drawing, in which a preferred exemplary embodiment of the present invention is illustrated. In the drawing

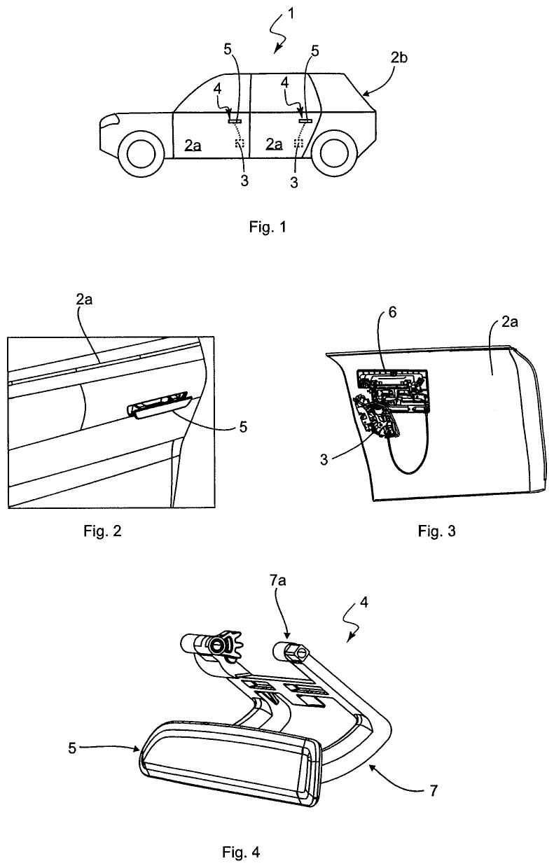

FIG. 1 shows a side view of a motor vehicle having a motor vehicle handle assembly schematically shown according to the present invention;

FIG. 2 shows a perspective view onto a door of a motor vehicle having a motor vehicle handle assembly according to the present invention;

FIG. 3 shows a perspective rear view onto the door of the motor vehicle including the motor vehicle handle assembly according to the present invention;

FIG. 4 shows a perspective view onto the motor vehicle handle assembly;

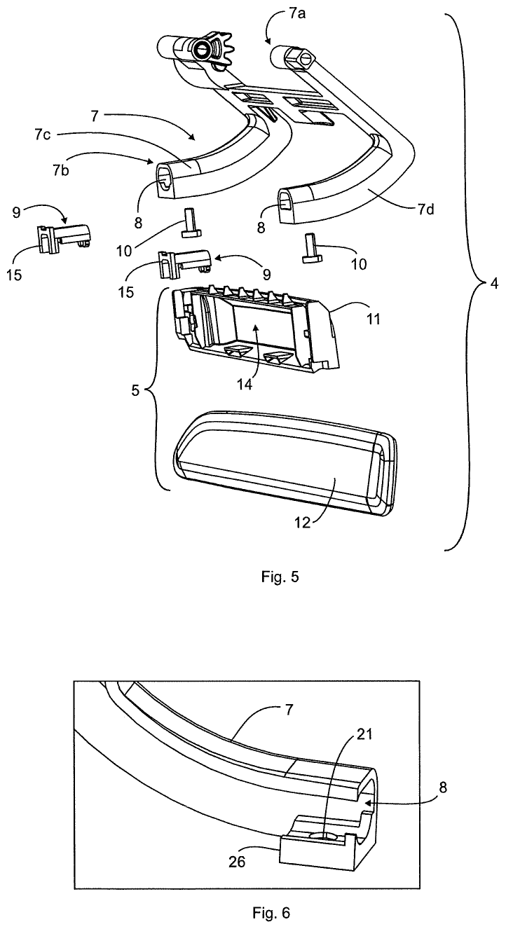

FIG. 5 shows a perspective detail view of the motor vehicle handle assembly from FIG. 4;

FIG. 6 shows a perspective sectional view for a handle element of the motor vehicle handle assembly;

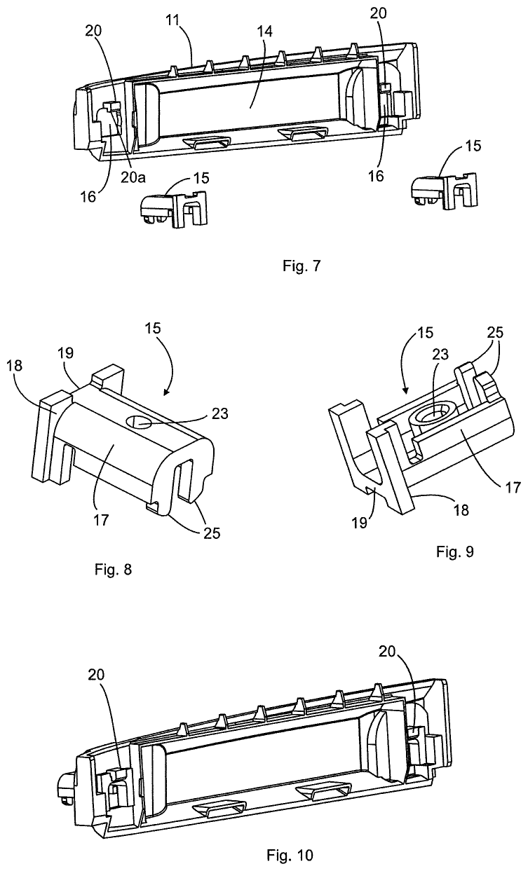

FIG. 7 shows a perspective view of a handle and inserter component of a handle element of the motor vehicle handle assembly;

FIG. 8 shows a perspective view onto an inserter component from FIG. 7;

FIG. 9 shows a further perspective view onto the inserter component from FIG. 8;

FIG. 10 shows a perspective illustration of the inserter component attached to the handle;

FIG. 11 shows a perspective view onto the handle including attached inserter components and onto a cover plate of the handle element;

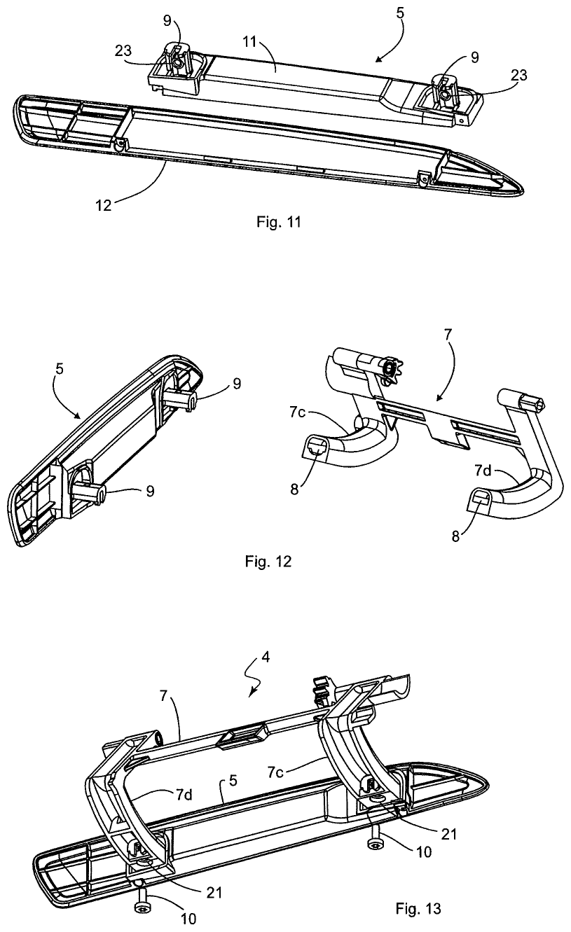

FIG. 12 shows a perspective view onto the handle element and a handle holder;

FIG. 13 shows a perspective view onto the handle element plugged onto the handle holder;

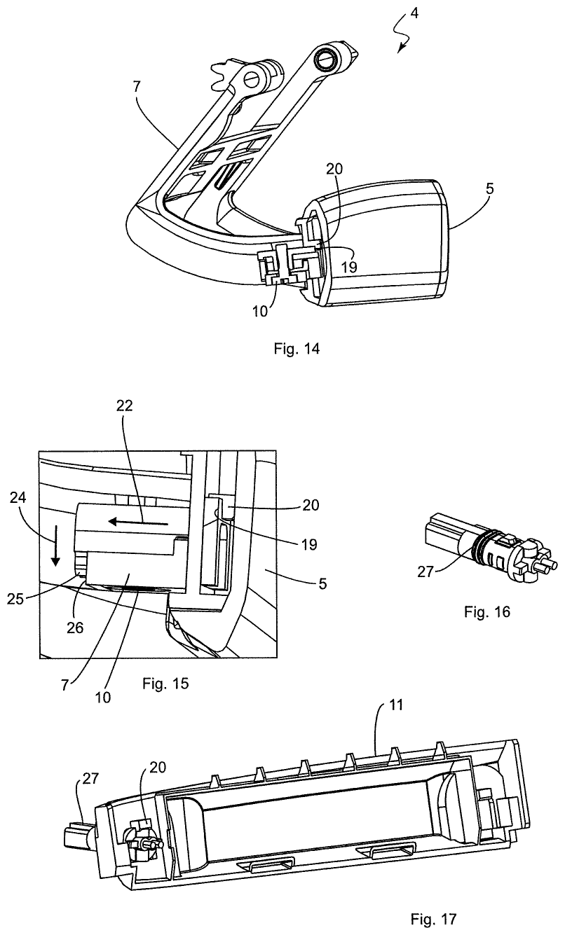

FIG. 14 shows a perspective sectional view of the connection between the handle element and the handle holder;

FIG. 15 shows a perspective detail view of the connection between the handle element and the handle holder;

FIG. 16 shows a two-pin plug in a perspective view; and

FIG. 17 shows in a perspective view the handling element, which is used for installing the two-pin plug.

In FIG. 1, a motor vehicle 1 in the form of a passenger car is shown in an exemplary manner, which in the example has four doors 2a (two of which are shown in FIG. 1) and a hatch or hatch door 2b. Both doors 2a and the hatch door 2b can be locked via respective motor vehicle locks 3 and can be unlocked by means of a motor vehicle handle assembly 4 indicated merely by way of example in FIG. 1 for the doors 2a in that a user operates a handle element 5 of motor vehicle handle assembly 4 configured as a type of a handle.

FIG. 2 shows a perspective view of door 2a, in which handle element 5 projects from door 2a. Handle element 5 is, in the non-actuated state, a handle element 5 extending in a flush manner with the door 2a, which subsequently is situated in a countersunk manner when it is not operated. FIG. 3 shows a rear view onto door 2a, in which a carrier element 6 can be seen, which is attached on the inside at door 2a and at which, as shown in the exemplary embodiment, handle assembly 4 is mounted.

In FIG. 4, motor vehicle handle assembly 4 is then shown in a perspective view in accordance with the present invention. Motor vehicle handle assembly 4 includes a rotatably mounted handle holder 7 and handle element 5 operable by a user, handle holder 7 having a first longitudinal end 7a which in the shown exemplary embodiment is mounted at door 2a via carrier element 6. Alternatively, it is also conceivable that handle holder 7 by its first longitudinal end 7a is rotatably mounted directly on the door.

In FIG. 5, motor vehicle handle assembly 4 according to the present invention is shown in a perspective detail view. Motor vehicle handle assembly 4 includes handle holder 7 rotatably mounted by its first longitudinal end 7a, and handle element 5 attached to a second longitudinal end 7b of handle holder 7, which for opening door 2a is operable by a user by pulling on handle element 5. In the illustrated exemplary embodiment, handle holder 7 is configured with two lever-like and L-shaped swing arms 7c and 7d. Also conceivable are alternative embodiments having only one swing arm or more than two swing arms. At each of the free, second longitudinal ends 7b of swing arms 7c, 7d, respectively one inserter component 8 is formed. Handle element 5 has two projecting fastening studs 9 (see, for example, FIG. 12). A respective fastening stud 9 during installation is plugged into an associated plug-in receptacle 8 and is there fixed with the aid of a respective connecting element 10, as will be described in greater detail below. As furthermore can be seen from FIG. 5, handle element 5 in the shown exemplary embodiment is configured from a plurality of parts and includes a handle 11 and a cover plate 12. Handle 11 is formed in a box-shaped manner and has a receiving space 14, in which, for example, electronic components for detecting the approach of the hand of a user can be accommodated. In this instance, lid-like cover plate 12 in the assembled state of the motor vehicle handle assembly 4 closes receiving space 14 open to one side. According to the present invention, two fastening studs 9 of handle element 5 are configured as respective inserter components 15. Inserter components 15 are fastened to handle 11 and are disposed in sections in receiving space 14. For this purpose, a section of a respective inserter component 15 pluggable into plug-in receptacle 8 of handle holder 7 extends through a corresponding opening 16 (see, for example, FIG. 7), which is configured in handle 11.

With reference to FIGS. 7 through 15, the assembly of motor vehicle handle assembly 4 according to the present invention and further details of the components already previously mentioned are subsequently described. In FIG. 7, handle 11 is shown including its two openings 16, which are disposed at the respective longitudinal ends of handle 11. An associated inserter component 15 is plugged from the inside of handle 11 into a respective opening 16. Inserter component 15 has an elongated base body 17 and a supporting surface 18 configured at a longitudinal end, which is, compared to base body 17, configured circumferentially broadened (see, for example, FIGS. 8 and 9). A respective inserter component 15 during installation is now inserted by its base body 17 through an assigned opening 16 until supporting surface 18 rests on the edge of respective opening 16. This is because supporting surface 18 is dimensioned greater than the size of opening 16. Base body 17 of a respective inserter component 15 furthermore has a fixation surface 19, which is configured facing away from supporting surface 18. When inserting inserter component 15 through opening 16, an elastically moveable latching hook 20 engages at fixation surface 19. Latching hook 20 is respectively configured at an opening 16 (see, for example, FIGS. 7 and 10) in such a manner that a respective latching hook 20 engages behind respective fixation surface 19 of an associated inserter component 15 if supporting surface 18 rests on the edge of a respective opening 16. For this purpose, supporting surfaces 18 and fixation surface 19 are situated in receiving space 14. Latching hook 20 is configured having an oblique guide surface 20a (see FIG. 7) so that the elastically moveable latching hook 20 during insertion of inserter component 15 first elastically yields and then engages behind fixation surface 19. In other words, a respective latching hook 20 configured in receiving space 14 of handle 11 engages at fixation surface 19 and pushes respective supporting surface 18 formed onto base body 17 onto the edge of opening 16 in such a manner that inserter component 15 is releasably fixed to handle 11, as it is shown in FIG. 10. For the complex geometry of respective inserter component 15, it is advantageous if it is made from Zamak or from an alloy for zinc die-casting.

In a subsequent installation step, which is shown in FIG. 11, lid-like cover plate 12 is then connected to handle 11, in that cover plate 12 in a covering manner is situated at handle 11 and is screw-connected with the same. In doing so, handle element 5 having two fastening studs 9 is finished and can be connected to handle holder 7 in a subsequent installation step, which is shown in FIGS. 12 and 13.

FIG. 12 once more shows assembled handle element 5, from which two fastening studs 9 project. In a further step of the installation, two fastening studs 9 are plugged into respective plug-in receptacle 8 of handle holder 7, which is shown in FIG. 13. It shall be mentioned that handle holder 7 is previously disposed at door 2a and, by its two swing arms 7c, 7d, protrudes through respective through holes in door 2a. For this purpose, handle holder 7 by its first longitudinal end 7a is pivotably mounted either directly on door 2a or via a carrier 6 fastened to door 2a. To secure fastening studs 9 in plug-in receptacle 8, two connecting elements 10 are provided, which in the exemplary embodiment are configured as respective screws. A respective connecting element 10 is screwed into a bore 21, each of which is formed into a swing arm 7c, 7d. In FIGS. 14 and 15, respective sectional views are shown for the assembled state, from which the constructional details subsequently described become evident. In FIG. 14, it can be seen once more how elastically moveable latching hook 20 engages behind fixation surface 19 of inserter component 15. Furthermore, it can be seen how the screw head of connecting element 10 is countersunk in bore 21. For this purpose, connecting element 10 in handle holder 7 is screwed transverse to insertion direction 22 of fastening stud 9 (see, for example, FIG. 15) and extends through a passage opening 23 formed in respective fastening stud 9 (see, for example, FIGS. 8 and 9). In other words, respective connecting element 10 extends transversely in relation to insertion direction 22 of fastening stud 9 situated in a plugged-in manner in handle holder 7 and through passage opening 23 of fastening stud 9, respective connecting element 10 releasably and positively connecting handle holder 7 and handle element 5 to each other.

For installing handle element 5 at handle holder 7, it is moreover to be mentioned that, during installation, after inserting or in-plugging respective fastening studs 9 in insertion direction 22 and before screw-connecting connecting element 10, a lateral movement 24 with regard to insertion direction 22 occurs (see, for example, FIG. 15). This lateral movement 24 results in that a latching lug 25 configured at a respective fastening stud 9 engages behind a holding section 26 configured within respective plug-in receptacle 8 (see, for example, FIGS. 6 and 15). Correspondingly, a respective fastening stud 9 by its latching lug 25 engages behind holding section 26 configured within plug-in receptacle 8 in such a manner that a movement of fastening studs 9 out of plug-in receptacle 8 and against insertion direction 22 is blocked. With the aid of connecting element 10, the positioning of fastening stud 9 is then secured within plug-in receptacle 8.

In FIGS. 16 and 17, it is finally shown that handle 11 before assembly with cover plate 12 alternatively also can be used for installing a two-pin plug 27. For this purpose, two-pin plug 27 has a broadened foot section, which with the aid of latching hook 20 can be fixed to handle 11 so that plug 27 can be guided with the aid of handle 11 and be installed at a door handle assembly.

The present invention previously described is, of course, not limited to the described and illustrated embodiments. It is evident that the embodiment illustrated in the drawing may be altered by a plurality of changes obvious to the skilled person with regards to the intended application without leaving the realm of the present invention. The present invention includes everything which is included and/or illustrated in the drawing, including those scenarios obvious to the skilled person but differing from the concrete exemplary embodiment.

1. A motor vehicle handle assembly comprising a rotatably mounted handle holder, of which a first longitudinal end can be mounted at a door or a hatch of a motor vehicle, and a handle element operable by a user,
wherein a second longitudinal end of the handle holder is configured having to have at least one plug-in receptacle and the handle element comprises at least one fastening stud projecting from the handle element, and
wherein the at least one fastening stud of the handle element is disposed in the at least one plug-in receptacle in a plugged-in manner,
at least one connecting element which extends transversely to an insertion direction of the at least one fastening stud disposed in the handle holder in a plugged-in manner and through a passage opening of the at least one fastening stud, and wherein the at least one connecting element releasably and positively connects the handle holder and the handle element with each other.

2. The motor vehicle handle assembly according to claim 1, wherein the handle holder is configured to have at least one lever-shaped swing arm, wherein the plug-in receptacle is formed at a free longitudinal end of the at least one swing arm.

3. The motor vehicle handle assembly according to claim 1, characterized in that wherein the at least one fastening stud is configured to have at least one latching lug, which engages, in the at least one fastening stud disposed in a plugged-in manner in the at least one plug-in receptacle, engages behind a holding section configured within the at least one plug-in receptacle in such a manner that a movement of the at least one fastening stud out of the plug-in receptacle is blocked.

4. The motor vehicle handle assembly according to claim 1, characterized in that wherein the handle element is formed from a handle and a lid-like cover plate, wherein the handle comprises a receiving space closed off by the cover plate for accommodating electrical components.

5. The motor vehicle handle assembly according to claim 4, wherein the at least one fastening stud is configured as an inserter component, which in sections is fixed in the receiving space of the handle and which extends through an opening configured in the handle.

6. The motor vehicle handle assembly according to claim 5, wherein the inserter component comprises a base body and a fixation surface configured at the base body, wherein a latching hook configured in the receiving space of the handle engages at the fixation surface and a supporting surface formed onto the base body pushes onto the edge of the opening in such a manner that the inserter component is releasably fixed to the handle.

7. The motor vehicle handle assembly according to claim 5, wherein the inserter component is made of Zamak.

8. The motor vehicle handle assembly according to claim 1, wherein the at least one connecting element is a screw, which is screwed in at least into the handle holder transversely to the insertion direction of the at least one fastening stud and which extends through the passage opening configured in the at least one fastening stud.
